(19) United States
(12) Patent Application Publication
(10) Pub. No.: US 2018/0236918 A1
(43) Pub. Date: Aug. 23, 2018

(54) PASSENGER COMPARTMENT CARPET ASSEMBLY, AND METHOD FOR ASSEMBLING SUCH AN ASSEMBLY

(71) Applicants: PSA AUTOMOBILES S.A., Poissy (FR); AUTONEUM MANAGEMENT AG, Winterthur (CH)

(72) Inventors: Patrick CHANUDET, Courbevoie (FR); Emeline BERLIOZ, Viroflay (FR); Patricia STRASSER, Antony (FR); Mathias KOSSANYI, Paris (FR)

(21) Appl. No.: 15/553,511

(22) PCT Filed: Feb. 23, 2016
(86) PCT No.: PCT/FR2016/050416

§ 371 Date: Aug. 24, 2017

(30) Foreign Application Priority Data
Feb. 27, 2015 (FR) 1551684

(51) Int. Cl. B60N 3/04; B62D 65/14; B32B 3/06; B32B 3/30; B32B 5/02; B32B 7/14; B32B 27/12; B32B 27/30; B32B 37/00; B32B 37/18; B32B 38/00; B29C 44/12; B29C 44/42; B29C 44/34

(52) U.S. Cl. CPC B60N 3/046; B29K 2075/00; B60N 3/048; B62D 65/14; B32B 3/06; B32B 3/30; B32B 5/02; B32B 7/14; B32B 27/12; B32B 27/302; B32B 37/0076; B32B 37/182; B32B 38/0012; B29C 44/1228; B29C 44/42; B29C 44/34; B32B 2038/0084; B32B 2250/02; B32B 2325/00; B32B 2471/02; B32B 2605/003; B60N 3/042

(57) ABSTRACT

The invention relates to a passenger compartment carpet assembly for a vehicle comprising a packing piece (10), a passenger compartment carpet (20) and expandable material (30) injected into a volume present in particular between said packing piece (10) and said passenger compartment carpet (20), the passenger compartment carpet having a lower surface (25) facing towards an upper surface (15) of said packing piece (10). The passenger compartment carpet assembly according to the invention is characterized in that the upper surface (15) of the packing piece (10), when in contact with the lower surface (25) of the passenger compartment carpet (20), includes a first plurality of channels (11) configured in such a way that said channels (11), when injected with expandable material (30), cause the formation of strips of dried expandable material ensuring that the passenger compartment carpet (20) is retained on the packing piece (10).

The present invention relates to a passenger compartment carpet assembly and a method of assembly of such an assembly. The present invention proposes in particular a carpet assembly for the passenger compartment of a motor vehicle. More specifically, the invention relates to the production of a packing piece, with a view to the production of a passenger compartment carpet assembly on said packing piece, by means of an expandable material of the polyurethane foam type, injected into the volume existing between said packing piece and said carpet, while minimizing the required quantity of foam and facilitating the injection of said foam between said packing piece and said carpet.

The present invention thus relates to passenger compartment carpet assemblies comprising a packing piece made of expanded polystyrene or a packing piece forming an integrated structure made of plastic. In this context, the present invention proposes new means integrated with said packing piece, in particular with a view to optimizing the retention of the carpet on the packing piece by the injection of foam and minimizing the required quantity of foam.

According to the prior art, passenger compartment carpet assemblies comprise a carpet resting on a packing piece, said carpet and packing piece being retained in a mechanically integrated assembly by polyurethane foam injected into the volume existing around the packing piece, between the packing piece and the floor of the passenger compartment and between the packing piece and the passenger compartment carpet. The packing piece is immersed completely in the polyurethane foam. In particular, on the upper surface of the packing piece, the foam is produced according to the state of the art on the totality of the interface with the passenger compartment carpet with the aim of ensuring the retention of the carpet.

The polyurethane foam thus acts as a kind of glue for assembling the carpet on the packing piece.

A problem familiar to a person skilled in the art lies in retaining the carpet on the packing piece with a view to forming an integrated mechanical assembly, in the absence of free play, and without the need to inject large quantities of foam. For this purpose, according to the prior art, the carpet may be retained on the packing piece by means of vertical wells arranged in the carpet, cut starting from a lower surface of the carpet, in such a way as to permit the polyurethane foam, as it expands, to rise up into the carpet, in so doing forming retaining rods penetrating into the carpet.

Document FR2899171 describes a device that is representative of the state of the art, in the form of a bearing structure supporting a carpet, said carpet including housings permitting the foam to come into contact locally with the carpet, in order to ensure that it is retained in position.

However, the majority of the previously disclosed systems and their methods of manufacture exhibit the disadvantage of requiring a large quantity of foam, due to the fact that the polyurethane foam necessarily covers the entirety of the surface contained between the packing piece and the carpet.

A further disadvantage of these previously disclosed devices resides in the fact that the embedding of the carpet under load is important, due to the fact that the foam has a necessary thickness of at least 5 to 10 mm in order to permit its expansion during manufacture, in particular in order to favor the rising up of the foam into the wells.

This large thickness of foam situated between the carpet and the packing piece impairs the embedding performance under load. In fact, the polyurethane foam offers low resistance to compression under load. Furthermore, the large quantity of foam required in these previously disclosed devices entails a high cost.

In the context of a motor vehicle passenger compartment, however, the aim is to avoid the excessive embedding of the passenger compartment carpet under load. As a result of this, because of the large thickness of the polyurethane foam injected between the packing piece and the carpet in previously disclosed passenger compartment carpet assemblies, the structure of the packing pieces, which are made of expanded polystyrene or plastic, is configured in order to be highly rigid. This reinforcement of the structure of the packing pieces entails an additional cost and an increase in the mass of the previously disclosed passenger compartment carpet assemblies.

Furthermore, as far as the devices comprising vertical wells are concerned, there is a difficulty for the foam to rise up inside these cavities, since the latter are blind. The rigidity of these assemblies is consequently not satisfactory.

There is thus a need for a passenger compartment carpet assembly comprising a packing piece and a carpet retained by injected foam, and comprising retaining means configured to allow a reduced quantity of foam while assuring good rigidity for the assembly as a whole.

In this context, the invention relates to an original implementation of a packing piece for a passenger compartment carpet assembly, enabling the assembly of said packing piece with said carpet to be implemented by means of an expandable material of the polyurethane foam type, while minimizing the quantity of foam used and facilitating the injection of said foam.

In order to achieve this object, the packing piece of the passenger compartment carpet assembly according to the invention comprises a plurality of channels disposed on the surface of the packing piece positioned in contact with the carpet. During expansion of the foam, in the course of the process of manufacturing the assembly, said foam progresses into the ducts formed by said channels, between the upper surface of the packing piece and the lower surface of the carpet.

For this purpose, more specifically, the invention has as its object a passenger compartment carpet assembly for a motor vehicle comprising a packing piece, a passenger compartment carpet and expandable material injected into a volume that is present, in particular, between said packing piece and said passenger compartment carpet, the passenger compartment carpet exhibiting a lower surface facing towards an upper surface of said packing piece.

The passenger compartment carpet assembly according to the invention is characterized in that the upper surface of the packing piece, in contact with the lower surface of the passenger compartment carpet, includes a first plurality of channels configured in such a way that said channels, when injected with expandable material, cause the formation of strips of dried expandable material ensuring that the passenger compartment carpet is retained on the packing piece.

Advantageously, the upper surface of the packing piece includes a second plurality of mutually parallel channels, forming a non-zero angle with the channels of the first plurality of channels, said channels of the first plurality of channels being mutually parallel.

According to one embodiment, the expandable material is a polyurethane foam.

According to one embodiment, the packing piece is made of expanded polystyrene.

According to another embodiment, said packing piece may be made of plastic.

According to this embodiment, said packing piece may form an integrated support structure for the passenger compartment carpet.

The present invention also proposes a packing piece intended for a passenger compartment carpet assembly, as described briefly above, said packing piece including, on an upper surface, intended to face towards a lower surface of a passenger compartment carpet, a plurality of channels intended to permit the formation of strips of dried expandable material by expansion of the expandable material injected into the interior of said channels.

According to one embodiment, said channels are substantially mutually parallel.

The invention also relates to a method of assembly of a passenger compartment carpet assembly, as described briefly above, said method of assembly including:
a stage of grooving the upper surface of the packing piece, said upper surface being intended to face towards the lower surface of the passenger compartment carpet, in order to form channels on said upper surface;
a stage of positioning the passenger compartment carpet on the upper surface of said packing piece; and
a stage of injection of expandable material into the interior of said channels, such that said expandable material, as it is propagated into said channels, forms, as it dries, strips of dried expandable material capable of ensuring that said passenger compartment carpet is retained in position on said packing piece.

According to one embodiment of the method of assembly, the injected expandable material is a polyurethane foam.

The present invention and its various embodiments exhibit the advantages of minimizing the involvement of foam, reducing the embedding of the assembly under load and facilitating the propagation of the foam between the packing piece and the passenger compartment carpet in the course of the process of manufacturing said assembly.

Other characterizing features and advantages of the invention will become evident from a perusal of the detailed description of the embodiments of the invention, which are provided solely by way of example, and with reference to the drawings, in which:

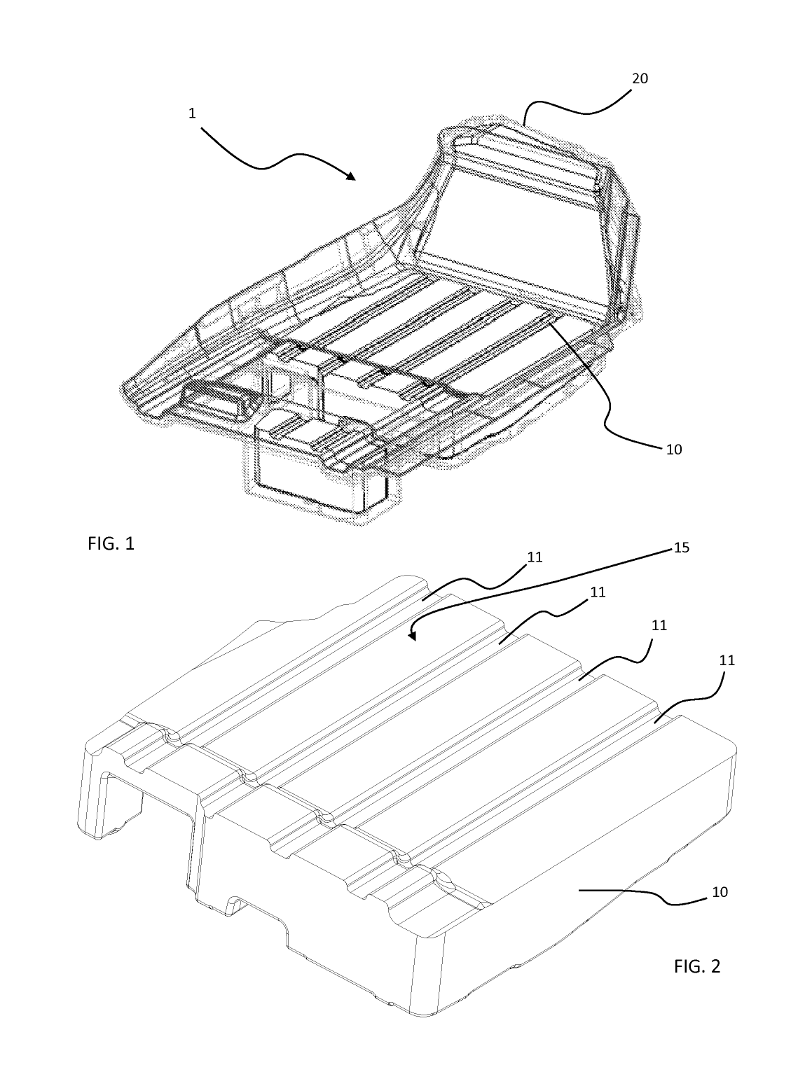

FIG. 1 depicts the schematic representation of a passenger compartment carpet assembly comprising a packing piece, in accordance with the present invention,

FIG. 2 depicts the schematic representation of a packing piece, of which an upper face comprises channels, in accordance with the present invention,

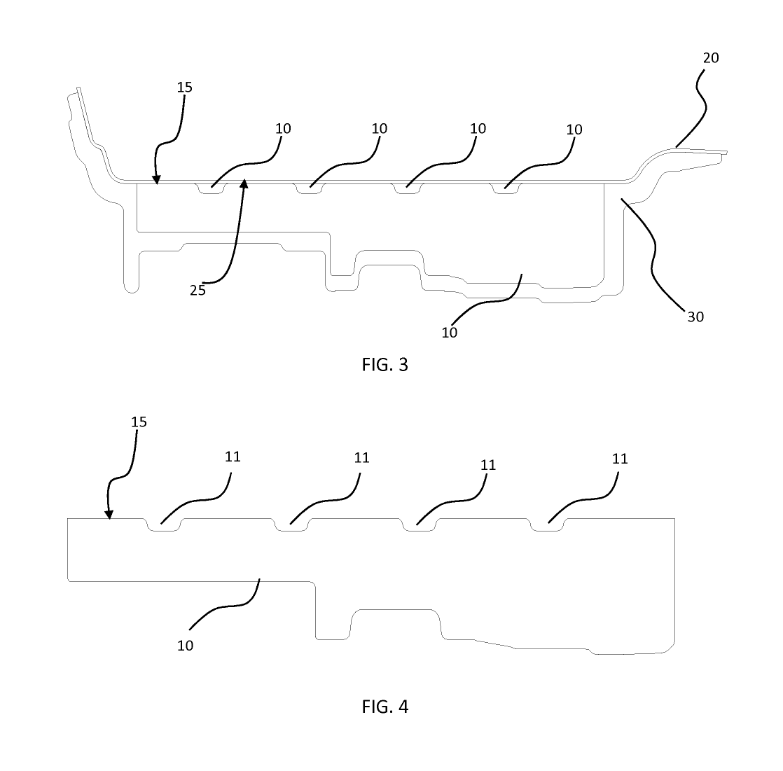

FIG. 3 depicts the schematic representation of a transverse section of an example of a passenger compartment carpet assembly, in accordance with the invention,

FIG. 4 depicts the schematic representation of a transverse section of packing piece for a passenger compartment carpet assembly, in accordance with the invention.

The embodiments described below refer more specifically to an implementation of the invention inside the passenger compartment of a motor vehicle. However, any implementation of the present invention in a different context, that is to say in any type of vehicle, is also covered by the present invention.

It should be noted, furthermore, that the present invention proposes a passenger compartment carpet assembly composed of a passenger compartment carpet and a support, also referred to here as a “packing piece”, as well as an expandable material injected into the volume existing between the packing piece and the passenger compartment carpet. It should also be noted that the expression “passenger compartment carpet” must be interpreted in a broad sense and relates both to a false floor, a foot support, a trim element or a floor covering adorning a passenger compartment of a motor vehicle.

FIG. 1 thus depicts a passenger compartment carpet assembly of a vehicle 1. This passenger compartment carpet assembly comprises a passenger compartment carpet 20 and a packing piece 10.

With reference to FIG. 2, according to the invention, the packing piece 10 comprises a plurality of channels 11, which are preferably mutually parallel, cut on an upper surface 15 of the packing piece, said upper surface 15 of the packing piece 10 being intended to face towards a lower surface 25 of the carpet 20.

More specifically, the carpet 20 of the carpet assembly 1 is supported, via its lower surface 25, on the upper surface 15 of the packing piece 10.

In the method according to the invention, the channels 11 are produced by grooving on the upper surface of the packing piece 10. These channels 11 thus form ducts between the upper surface 15 of the packing piece 10 and the lower surface 25 of the carpet 20 when said passenger compartment carpet 20 is positioned on said packing piece 10, in such a way that the carpet 20 rests on the packing piece 10, the lower surface 25 of the carpet being in contact with the upper surface 15 of the packing piece 10.

In a stage of the method of assembly according to the invention, involving the injection of an expandable material, such as foam 30 of the polyurethane type, into the volume existing around the packing piece 10 and, in particular between said packing piece 10 and the carpet 20, the packing piece and the carpet are positioned in a foam mold, the under surface of the passenger compartment carpet 20, that is to say its lower surface 25, being in contact with the upper surface 15 of the packing piece 10.

With reference to FIG. 3, the propagation of the foam 30 takes place between the packing piece 10 and the carpet 20. In particular, the injected foam is propagated in the ducts formed from the channels 11, between the upper surface 15 of the packing piece 10 and the lower surface 25 of the carpet 20.

The channels 11 facilitate the propagation of the foam 30, which is conventionally made of polyurethane, while minimizing the volume of foam 30 injected.

The method of assembly of the packing piece 10 with the passenger compartment carpet 20 is thus implemented by the expansion of the foam 30 into the interior of the channels 11.

At the end of the operation for the injection of the foam and the expansion of the latter, the passenger compartment carpet 20 is retained on the packing piece 10 by means of strips of foam corresponding to the ducts formed from the channels 11.

It should be noted that the same principle, according to which channels arranged in the packing piece permit the passenger compartment carpet to be retained, is applicable to the context of a packing piece supporting a passenger compartment carpet at the level of a foot rest.

In summary, the present invention relates to a passenger compartment carpet assembly comprising in particular a packing piece 10 as depicted in FIG. 4. The packing piece 10 exhibits, on its upper surface 15, in contact with the lower surface 25 of the carpet 20, channels 11 adapted to permit the propagation therein of an injected expandable material, such as polyurethane foam, in such a way as to form strips of foam capable of retaining said carpet 20 in position.

It should also be noted that the present invention is not limited to the examples described above and lends itself to numerous variants that are familiar to a person skilled in the art.

In particular, as mentioned previously, the method of assembly is applicable in particular to a false floor, positioned on an integrated supporting packing piece covering a portion of the vehicle body, or to a trim element, supported by an integrated supporting packing piece, in the interior of a vehicle passenger compartment.

1. A passenger compartment carpet assembly for a vehicle comprising:
a packing piece, a passenger compartment carpet, and expandable material injected into a volume present in particular between said packing piece and said passenger compartment carpet, the passenger compartment carpet having a lower surface facing towards an upper surface of said packing piece; and
wherein the upper surface of the packing piece, in contact with the lower surface of the passenger compartment carpet, includes a first plurality of channels configured in such a way that said channels, when injected with expandable material, cause the formation of strips of dried expandable material ensuring that the passenger compartment carpet is retained on the packing piece.

2. The passenger compartment carpet assembly for a vehicle as claimed in claim 1, wherein the upper surface of the packing piece includes a second plurality of mutually parallel channels, forming a non-zero angle with the channels of the first plurality of channels, said channels of the first plurality of channels being mutually parallel.

3. The passenger compartment carpet assembly for a vehicle as claimed in claim 1, wherein the expandable material is a polyurethane foam.

4. The passenger compartment carpet assembly for a vehicle as claimed in claim 1, wherein the packing piece is made of expanded polystyrene.

5. The passenger compartment carpet assembly for a vehicle as claimed in claim 1, wherein the packing piece is made of plastic.

6. The passenger compartment carpet assembly for a vehicle as claimed in claim 5, wherein said packing piece forms an integrated support structure for the passenger compartment carpet.

7. The passenger compartment carpet assembly for a vehicle as claimed in claim 1, wherein the packing piece includes, on an upper surface, intended to face towards a lower surface of the passenger compartment carpet, a plurality of channels intended to permit the formation of strips of dried expandable material by expansion of the expandable material injected into the interior of said channels.

8. The passenger compartment carpet assembly for a vehicle as claimed in claim 7, wherein said channels are substantially mutually parallel.

9. A method of assembly of a passenger compartment carpet assembly as claimed in claim 1, comprising:
a stage of grooving the upper surface of the packing piece, said upper surface being intended to face towards the lower surface of the passenger compartment carpet, in order to form channels on said upper surface;
a stage of positioning the passenger compartment carpet on the upper surface of said packing piece; and
a stage of injection of expandable material into the interior of said channels, such that said expandable material, as it is propagated into said channels, forms, as it dries, strips of dried expandable material capable of ensuring that said passenger compartment carpet is retained in position on said packing piece-.

10. The method of assembly as claimed in claim 9, wherein the injected expandable material is a polyurethane foam.
